(19) United States
(12) Patent Application Publication
(10) Pub. No.: US 2014/0201321 A1
(43) Pub. Date: Jul. 17, 2014

(54) SYSTEMS, METHODS, AND/OR APPARATUS FOR ENABLING COMMUNICATION BETWEEN DEVICES USING DIFFERENT COMMUNICATION PROTOCOLS

(71) Applicants: Andrew Paul Donaghey, Camberwell (AU); David Victor Octave Le Blanc, Ashburton (AU)

(72) Inventors: Andrew Paul Donaghey, Camberwell (AU); David Victor Octave Le Blanc, Ashburton (AU)

(21) Appl. No.: 14/127,423

(22) PCT Filed: Jun. 25, 2012
(86) PCT No.: PCT/AU2012/000741

§ 371 Date: Mar. 27, 2014

Related U.S. Application Data
(60) Provisional application No. 61/577,396, filed on Dec. 19, 2011.

(30) Foreign Application Priority Data
Jun. 29, 2011 (AU) 2011902569

(51) Int. Cl. H04L 29/06

(52) U.S. Cl. CPC H04L 69/02
USPC 709/217

(57) ABSTRACT

An integration system for enabling communication between service providers and end-devices, comprising at least one memory for storing data about end-devices and an interface for receiving communications from service providers intended for a plurality of end-devices and retransmitting the communication to the plurality of end-devices. The plurality of end-devices being configured to communicate with two or more different service providers and the integration system is configured to translate the incoming communication from the service provider to the protocol corresponding to the end-device.

### CROSS REFERENCE

This application claims priority from Australian Patent Application No. 2011902569, filed 29 Jun. 2011 and U.S. Patent Application No. 61/577,396, filed 19 Dec. 2011, each of which are incorporated herein by reference in their entirety.

### FIELD

This disclosure relates to systems, methods, and/or apparatus for enabling communication between devices using different communication protocols and to integration systems, apparatus, and/or methods for assisting with selection, configuration and/or delivery of applications to end devices and/or infrastructure devices.

### BACKGROUND

Infrastructure providers, such as water and electricity utilities, retailers and distributors, are currently working to deploy infrastructure networks to provide their customers with greater flexibility and control over the services the providers deliver and how the delivered services are charged. These networks connect end devices, such as meter devices, to a network to enable duplex digital communication with the provider's equipment. The networks are often referred to as “Smart Grids” because they provide additional functionality to both the providers and their customers or users.

One of the problems in developing these networks is that they are being built on existing distribution equipment, and a variety of proprietary or infrastructure provider specific technology is being utilized. This makes it difficult to access end devices on different, and often disparate networks, and can result in considerable duplication of equipment and/or restrictions on the functionality that can be deployed to the devices. The problem is exacerbated as the number of infrastructure components increase making it extremely difficult to manage the equipment.

Users and/or customers want more control and/or flexibility regarding how they use their end devices. For example, there is a demand for remote management, control via a web browser, control via a hand held device, reception of frequent updates with additional features, near instantaneous support from providers and/or combinations thereof. Providers themselves also want to meet this demand while still being able to maintain, where possible, their existing infrastructure and/or components deployed in their networks. Accordingly, there is a need to provide a technical solution which enables integration between the user or customer and infrastructure provider equipment, despite the disparate network components used and the limitations discussed herein.

Integrating legacy systems and/or components over an existing communications network, such as the Internet, using modules such as web services adaptors, presents at least one or more of the following problems as well as other problems not listed here:
(i) communications integration to ensure the components communicate using a shared communications protocol;
(ii) data transformation integration to ensure data is passed in a common language and/or format, e.g. XML, CSV, Mainframe EBCDIC records; and
(iii) security integration to authenticate the communicating parties and ensure data integrity and privacy.

The one or more of the above problems as well as other problems not list above can be addressed by developing an individual solution with solution specific integration adaptors to specific nodes, but this may involve one or more disadvantages, for example:

A detailed process analysis needs to be performed to develop a data model and a process model to deal with bidirectional data integration and multiple data transformations. This is time consuming, even if transformations are adapted to simply express the data in XML using web services.
(ii) For node to node integration, a security module often needs to be built to ensure adherence with security policies of third parties, involving additional time and cost.
(iii) Building and deploying the service end points or adaptors requires detailed system knowledge and a considerable development time involving individual developers.
(iv) Infrastructure providers require considerable scalability and reliability. For example, millions of end devices may be potential end nodes and it is desired to provide high levels of reliability and/or useability, particularly for a gas or electricity network.

Existing problems make it difficult for infrastructure providers to deploy additional applications and/or modules, that provide additional functionality, to end devices at an acceptable speed and/or acceptable cost. The technical difficulties prevent users or customers from simply selecting and deploying a wide variety of possible applications over a variety of infrastructure networks.

Accordingly, there is a need for systems, methods, and/or apparatus for enabling communication between devices using different communication protocols and for integration systems, apparatus, and/or methods for assisting with selection, configuration and/or delivery of applications to end devices and/or infrastructure devices. This disclosure is directed to overcoming and/or ameliorating at least one or more of the disadvantages of the prior art, or at least providing a useful alternative; as will become apparent from the discussion herein.

### SUMMARY

Certain embodiments described herein may comprise an integration system for enabling communication between service providers and end-devices, the integration device comprising: at least one memory for storing data about end-devices; an interface for receiving communications from service providers intended for a plurality of end-devices and retransmitting the communication to the plurality of end-devices; wherein the plurality of end-devices are configured to communicate with two or more different service providers and the integration system is configured to translate the incoming communication from the service provider to the protocol corresponding to the end-device.

In certain embodiments, the integration device may further comprise a common interface for receiving communications from service providers using a common protocol.

In certain embodiments, the integration device may further comprise a processor for implementing access management protocols across a plurality of service providers.

In certain embodiments, the access management protocols may comprise security protocols.

In certain embodiments, the security protocols may comprise at least one of authentication, service provider rights and roles, end-device data, or service provider data.

In certain embodiments, the integration device may further comprise an application kiosk for storing applications for distribution to the end-devices.

In certain embodiments, the service providers desire to communicate with the end-devices to provide applications to the end-devices.

In certain embodiments, the service providers desire to communicate with the end-devices to query the end-devices.

In certain embodiments, the system may support the communication of video between service providers and end-devices (e.g., service providers may be able to request photos or video from end-devices using cameras connected to the system).

In certain embodiments, the service provider may have access to a limited set of device commands, e.g., a manufacturer may have access to all device commands because they created and deployed the application to the device, but an energy retailer may only have access to a limited number of the device commands—e.g., device “off” & “pause” but not device' “on”. In certain embodiments, this information may be in, e.g., the profile—access level.

In certain embodiments, the service providers desire to request the protocol corresponding to the end device from the integration system.

In certain embodiments, the integration system may further configured to translate communications from the end-devices into a protocol corresponding to the service provider.

In certain embodiments, the end-devices may comprise at least one of customer premise utility devices, mobile devices, hand-held devices, and/or mounted tracking devices or sensors.

In certain embodiments, the service providers may comprise at least one of end-device manufactures, utility companies, and/or third party service providers.

In certain embodiments, the manufactures may be given rights to update firmware on the end-devices and provide applications and the remaining service providers are given rights to query the end devices.

In certain embodiments, the manufacturers may be given rights to update firmware on the end-devices and provide applications and the remaining service providers desire to request the protocol corresponding to the end device from the integration system.

In certain embodiments, there are at least 100 end-devices using at least 3 different communication protocols.

In certain embodiments, there may be at least 10,000 end-devices using at least 5 different communication protocols.

In certain embodiments, there may be at least 100,000 end-devices using at least 10 different communication protocols.

Certain embodiments may related to a method for communicating with a plurality of end-devices the method comprising: receiving a communication from a service provider; identifying which plurality of end-devices the communication was intended for; determining which of two or more communication protocols the plurality of end-devices use; translating the received communication into the plurality of different communication protocols; and retransmitting the communication to the identified plurality of end-devices.

In certain embodiments, the communications from the service providers may be received using a common protocol.

In certain embodiments, the method may further comprise implementing access management protocols across a plurality of service providers.

In certain embodiments, the access management protocols may comprise security protocols.

In certain embodiments, the security protocols may comprise at least one of authentication, service provider rights and roles, end-device data, or service provider data.

In certain embodiments, the method may further comprise storing applications for distribution to the end-devices.

In certain embodiments, the service providers may desire to communicate with the end-devices to provide applications to the end-devices.

In certain embodiments, the service providers may desire to communicate with the end-devices to query the end-devices.

In certain embodiments, the service providers may desire to request the protocol corresponding to the end device from the integration system.

In certain embodiments, the method may further comprise translating communications from the end-devices into a protocol corresponding to the service provider.

In certain embodiments, the end-devices may comprise at least one of customer premise utility devices, mobile devices, hand-held devices, and/or mounted tracking devices.

In certain embodiments, the service providers may comprise at least one of end-device manufactures, utility companies, and/or third party service providers.

In certain embodiments, the manufactures may be given rights to update firmware on the end-devices and provide applications and the remaining service providers are given rights to query the end devices.

In certain embodiments, the manufacturers may be given rights to update firmware on the end-devices and provide applications and the remaining service providers may desire to request the protocol corresponding to the end device from the integration system.

In certain embodiments, there may be at least 100 end-devices using at least 3 different communication protocols.

In certain embodiments, there may be at least 10,000 end-devices using at least 5 different communication protocols.

In certain embodiments, there may be at least 100,000 end-devices using at least 10 different communication protocols.

Certain embodiments may provide for an integration system for enabling communication between service providers and end-devices, the integration system comprising: a database maintaining data on end-devices; an application kiosk storing application files for the end-devices, the application files comprising: (i) a profile for an application representing functional capabilities of the respective application and comprising available commands for respective devices; and (ii) a policy including configuration data for a deployment environment; a user interface enabling access to the system by users; and a services interface for uploading applications to the application kiosk, deploying applications from the application kiosk to a plurality of end-devices based on user requests and the respective application policies, and communicating with the deployed applications using commands defined in the respective application profiles of the applications.

In certain embodiments, the end-devices may comprise at least one of customer premise devices, mobile devices, hand-held devices, and/or mounted tracking devices such as trucks and plant or shipping equipment or logistics or security or sensor.

In certain embodiments, the system may also comprise security management services for managing authentication and access to the integration system.

In certain embodiments, the services interface is a web services interface.

Certain embodiments may provide for an integration system for enabling communication between service providers and end-devices including components for selecting and deploying different applications to a plurality of end-devices over a plurality of different infrastructure provider networks.

In certain embodiments, the integration system may also comprise a user interface for remotely selecting applications and causing installation on remote end devices of different infrastructure provider networks.

Certain embodiments may provide for an integration system for enabling communication between service providers and end-devices, comprising: an application kiosk storing applications to be run on customer devices, the applications comprising one or more of the following: (i) application code; (ii) a profile representing available commands for the application when run on different respective customer devices; (iii) firmware code; and (iv) configuration data for a deploying the application on different respective customer devices and in different environments; and a web services interface for: (i) uploading applications to the application kiosk, (ii) deploying applications from the application kiosk to end-devices based on user requests, the configuration data and the code of the applications, and (iii) communicating with the deployed applications using commands defined in the respective profiles of the applications; and a transformation component for processing messages received from customers and generating commands from the messages using the profiles to control the devices.

In certain embodiments, the transformation component may execute transformation rules of said profiles to generate the commands.

In certain embodiments, the transformation component may execute the transformation rules of said profiles to convert data from the end-devices, by the web services interface, into messages for generating displays for users.

Certain embodiments of the present disclosure provide a system, comprising:

a database for maintaining information on customers and devices at customer's premises;

an application kiosk storing application files for customer devices, the files comprising:
(i) application profile representing functional capabilities of the respective application and including available commands for respective devices; and/or
(ii) application policy including configuration data for a deployment environment;

security management services for managing at least one of authentication and access to the integration system;

an interface enabling authenticated access to the system; and

a web services interface for uploading applications to the application kiosk, deploying applications from the application kiosk to devices based on user requests and the respective application policy, and communicating with the deployed applications using commands defined in the respective application profiles of the applications.

Certain embodiments also provide an integration system, including:

an application kiosk storing application bundles for applications to be run on customer devices, the bundles may comprise:
(i) a profile representing available commands for the application when run on different respective customer devices; and
(ii) configuration data for deploying the application on different respective customer devices and in different environments; and

a web services interface for uploading application bundles to the application kiosk, deploying applications from the application kiosk to devices based on user requirements and using the configuration data and code of the applications, and communicating with the deployed applications using commands defined in the respective profiles of the applications; and

a transformation component for processing messages received from user equipment and generating commands from the messages using the profiles to control the devices.

As well as the embodiments discussed in the summary, other embodiments are disclosed in the specification, drawings and claims. The summary is not meant to cover each and every embodiment, combination or variations contemplated with the present disclosure.

Certain embodiments may provide an application kiosk storing application files for the end devices, the application files comprising:
(i) a profile for an application representing functional capabilities of the respective application and comprising available commands for respective devices; and
(ii) a policy including configuration data for a deployment environment;

In certain embodiments, the application kiosk may be part of a system that comprises the application kiosk, a user interface enabling access to the system by users; and a services interface for uploading applications to the application kiosk, deploying applications from the application kiosk to devices based on user requests and the respective application policy, and communicating with the deployed applications using commands defined in the respective application profiles of the applications.

In certain embodiments, the end devices locations comprises at least one of a customer premises, mobile devices, hand-held devices, mounted tracking devices such as trucks and plant or shipping equipment or logistics or security.

In certain embodiments, the system may also comprise security management services for managing authentication and access to the integration system.

In certain embodiments, the services interface is a web services interface.

In certain embodiments, an integration system comprising components for selecting and deploying different applications to at a plurality of end devices over a plurality of different infrastructure provider networks.

In certain embodiments, the integration system may comprise a user interface for remotely selecting applications and causing installation on remote end devices of different infrastructure provider networks.

In certain embodiments, an application kiosk storing application bundles for applications to be run on customer devices may be provided. The application bundle may comprise one or more of the following:
(i) application code
(ii) a profile representing available commands for the application when run on different respective customer devices; and
(iii) firmware code
(iv) configuration data for a deploying the application on different respective customer devices and in different environments; and

In certain embodiments, the transformation component may execute transformation rules of said profiles to generate the commands.

In certain embodiments, the transformation component may execute the transformation rules of said profiles to convert data from the devices, by the web services interface, into messages for generating displays for users.

In certain embodiments, the systems and devices may exhibit greater flexibility and/or control over various processes. For example, devices may receive updates, new applications, corrective measurements, etc. In substantially real time (e.g., within 1, 5, 10, 20, 30, 60 minutes of the update being available).

In certain embodiments, the devices and systems may support more devices and including devices across multiple network types: For example, the system may support devices from different manufactures and/or devices with different (potentially proprietary) communication methods without the need for multiple interfaces and/or separate systems. In certain embodiments, the devices may be manufactured by at least 2, 3, 4, 5, 6, 7, 8, 9, 10, etc. different manufacturers.

In certain embodiments, the systems and devices may have the ability to connect to multiple platforms from a single interface or from substantially fewer interfaces. For example, a single interface may be configured to connect to at least 3, 4, 5, 6, 7, 8, 9, 10 etc. different platforms. In certain embodiments, the platforms may comprise wired and/or wireless communication standards. In certain embodiments, the communication protocols may be proprietary.

### BRIEF DESCRIPTION OF THE FIGURES

Features, aspects, and advantages of the present disclosure will become better understood with regard to the following description, appended claims, and accompanying figures wherein:

FIG. 1 is a block diagram of an integration system connected to a customer computer and an infrastructure provider communications network, according to certain embodiments;

FIG. 2 is a block diagram of an exemplary hardware architecture of the integration system, according to certain embodiments;

FIG. 3 is a block diagram of an exemplary software architecture of the integration system, according to certain embodiments;

FIG. 4 is a block diagram of an exemplary transformation services component of the integration system, according to certain embodiments;

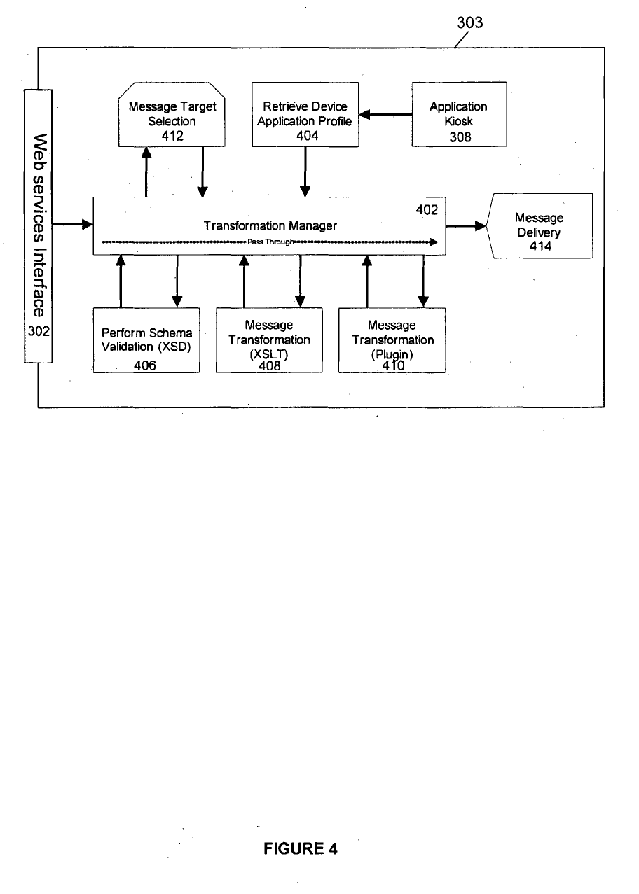

FIG. 5 is a block diagram of different service providers deploying applications on different networks and different customer devices, according to certain embodiments;

FIG. 6 is a flow diagram of an exemplary component update process of the integration system, according to certain embodiments;

FIG. 7 is a block diagram of an integration system connected to the different user equipment and different infrastructure provider networks, according to certain embodiments;

FIG. 8 is a block diagram of an infrastructure provider network connected to a customer gateway, according to certain embodiments;

FIG. 9 is a block diagram illustrating a device roaming between the two integration systems, according to certain embodiments;

FIG. 10 is a block diagram of an integration system connected to a variety of customer devices and infrastructure provider equipment, according to certain embodiments;

FIG. 11 is a block diagram of an integration system connected to a variety of customer devices and infrastructure provider equipment, according to certain embodiments;

FIG. 12 is a block diagram of an integration system interconnecting a plurality of institutions (e.g., banks), according to certain embodiments

FIG. 13 is a block diagram of an integration system for handling various aspects of application processing in accordance with certain embodiments.

### DETAILED DESCRIPTION

The present disclosure will now be described in detail with reference to one or more embodiments, examples of which are illustrated in the accompanying drawings. The examples and embodiments are provided by way of explanation and are not to be taken as limiting to the scope of the disclosure. Furthermore, features illustrated or described as part of one embodiment may be used by themselves to provide other embodiments and features illustrated or described as part of one embodiment may be used with one or more other embodiments to provide a further embodiments. It will be understood that the present disclosure will cover these variations and embodiments as well as other variations and/or modifications.

The features disclosed in this specification (including accompanying claims, abstract, and drawings) may be replaced by alternative features serving the same, equivalent or similar purpose, unless expressly stated otherwise. Thus, unless expressly stated otherwise, each feature disclosed is one example of a generic series of equivalent or similar features.

In general, embodiments described herein may comprise an integration system for enabling communication between service providers and end-devices. In certain embodiments, the integration device may include at least one memory for storing data about end-devices; and an interface for receiving communications from service providers intended for a plurality of the end-devices and retransmitting the communication to the plurality of end-devices. In certain embodiments, the plurality of end-devices may be configured to communicate with two or more different service providers and the integration system may be configured to translate the incoming communication from the service provider to the communication protocol corresponding to the end-device.

In certain embodiments, the integration device may further comprise a common interface for receiving communications from service providers using a common protocol (e.g., XML, SOAP, REST, JSON, AMQP)).

In certain embodiments, the integration device may further comprise a processor for implementing access management protocols across a plurality of service providers.

In certain embodiments, the access management protocols may comprise security protocols (e.g., PKI, RADIUS, Active Directory, LDAP)).

In certain embodiments, the security protocols may comprise at least one of authentication, service provider rights and roles, end-device data, or service provider data.

In certain embodiments, the integration device may further comprise an application kiosk for storing applications for distribution to the end-devices (e.g., applications for monitoring, billing, geo fencing, alarming, self-healing, redundancy, device control, automated control, over temperature, model upgrades, building control, health, utilities, agriculture, asset management, logistics, water, gas, home automation).

In certain embodiments, the service providers may desire to communicate with the end-devices to provide applications to the end-devices.

In certain embodiments, the service providers may desire to communicate with the end-devices to query the end-devices (e.g., software versions, hardware versions, device status, interface status, location, errors, temperature, voltage.).

In certain embodiments, the service providers may desire to request the protocol corresponding to the end device from the integration system (e.g., IPV4, IPV6, SEP 1.0, SEP 1.1, FMP, Zigbee, Coronis, IEC61850, IEC61107, MQTT, MQTTS, AMQP,).

In certain embodiments, the integration system may be further configured to translate communications from the end-devices into a protocol corresponding to the service provider.

In certain embodiments, the end-devices may comprise at least one of customer premise utility devices, mobile devices, hand-held devices, and/or mounted tracking devices or sensors.

In certain embodiments, the service providers may comprise at least one of end-device manufactures, utility companies, and/or third party service providers (e.g., Manufactures: General Electric, Samsung, Siemens, LG, Elster, Itron, Whirlpool, Electrolux. Utilities: Pacific Gas & Electric, San Diego Gas & Electric, Florida Power & Light Company. Third Parties: IBM, Computer Science Corporation, Logica and Value Added Resellers (VAR's).

In certain embodiments, the manufactures may be given rights to update firmware on the end-devices and provide applications and the remaining service providers are given rights to query the end devices.

In certain embodiments, the manufacturers may be given rights to update firmware on the end-devices and provide applications and the remaining service providers desire to request the protocol corresponding to the end device from the integration system.

In certain embodiments, there may be at least 100 (e.g., at least 75, 100, 150, 200, 500, 1000, 10000, 25000, 50000, 100000, 1000000, 10000000 etc.) end-devices using at least 3 (e.g., at least 2, 3, 4, 5, 10, 15, 20, 25 etc.) different communication protocols. In certain embodiments, there may be between 50 to 10 million, 100 to 10 million, 100 to 1 million, 100 to 100,000, 500 to 200,000, 1000 to 500,000, 5000 to 200,000, 5000 to 500,000, 5000 to 2 million, 10,000 to 50 million, 100,000 to 50 million, 250,000 to 50 million end devices using 3 to 25, 3 to 15, 3 to 10, 4 to 25, 4 to 15, 4 to 10, 5 to 25, 5 to 15, 5 to 10, 10 to 25, 10 to 15, or 10 to 20 different communication protocols. For example, devices may receive updates, new applications, corrective measurements, etc. At least 60%, 70%, 80%, 90%, 95%, 97%, 99%, or 99.5% of the end devices may be updated in within 1, 5, 10, 20, 30, 60 minutes, 2 hours, 3 hours, 8 hours, 24 hours, or 48 hours of the update being available. Alternatively or in combination, the end devices may provide content, information and/or data to service providers in substantially real time such that the service provides can receive content from end devices using at least (e.g., at least 2, 3, 4, 5, 10, 15, 20, 25 etc.) different communication protocols. In certain embodiments, at least 60%, 70%, 80%, 90%, 95%, 97%, 99%, or 99.5% of the end devices may provide content, information and/or data to service providers within 1, 5, 10, 20, 30, 60 minutes, 2 hours, 3 hours, 8 hours, 24 hours, or 48 hours of the update being available.

Other combinations of the number of end-devices and different communication protocols are also contemplated in combination with the time it takes end devices to receive updates, new applications, corrective measurements, etc and/or the time it takes end devices to provide content, information and/or data to service providers.

In certain embodiments, there may be at least 10,000 end-devices using at least 5 different communication protocols.

In certain embodiments, there may be at least 100,000 end-devices using at least 10 different communication protocols.

Certain embodiments are directed to devices and/or systems may support more devices and including devices across multiple network types. For example, the system may support devices from different manufactures and/or devices with different (potentially proprietary) communication methods without the need for multiple interfaces and/or separate systems. In certain aspects, the devices may be manufactured by at least 2, 3, 4, 5, 6, 7, 8, 9, 10, etc. different manufacturers. In certain aspects, the devices may be manufactured 1 to 20, 2 to 10, 2 to 20, 3 to 15, 5 to 25, 3 to 12, etc. by at least different manufacturers.

Certain embodiments are directed to systems and/or devices that may have the ability to connect to multiple platforms from a single interface or from substantially fewer interfaces. For example, a single interface may be configured to connect to at least 3, 4, 5, 6, 7, 8, 9, 10 etc. different platforms. For example, a single interface may be configured to connect to at 2 to 10, 3 to 10, 4 to 10, 2 to 5, 3 to 8, 4 to 8, etc. different platforms. The platforms may comprise wired and/or wireless communication standards. The communication protocols may be proprietary.

The present disclosure describes how, equipment and processes may be used to achieve the exemplary systems and/or methods described herein. The system describes an exemplary mechanism for making available microcontrollers with a substantially uniform set of applications and a substantially uniform method of control for use in end-devices (e.g., consumer appliances, industrial equipment, monitoring and switching systems), enabling, e.g., one or more of the following;
Delivery of applications to end-devices;
Enabling or activating applications and/or application features on such devices;
Management and Control via applications over a communications medium
Publishing and Consumption of applications as “services” via the use of Standards based internet protocols, such as a XML over HTTP (SOAP and REST are examples of this);
Functional features may include, for example, one or more of the following;
   Devices registering (e.g., automatically registering) with the infrastructure where possible;
   Applications deployed via application repositories, collectively known as the “App Kiosk”;
   Communication with, and/or control of, the Devices and/or Gateway via the Infrastructure Provider networks;
   Aggregation and Publishing of devices and application services through the use of one or more integration systems; and/or
   The global publishing and discovery of applications, profiles, and/or policies;
   authentication of devices;
   authentication of users; and/or
   encryption of all communications.

As used herein in certain embodiments, the following terms may have the exemplary meaning detailed herein:

| | |
|---|---|
| Customer | Individual or Business who purchases an asset (e.g., equipment, |
| | appliance or device) which may be connected to an integration |
| | system as described herein. |
| Infrastructure | Entity providing the communication and computation resources |
| Provider | to create an instance of the system and/or method described |
| | herein. (e.g., Management Systems, Concentrators, |
| | communications network, etc.) Also described as a |
| | “Communication Provider” supporting communications over |
| | 3G, xDSL (DSL, ADSL, HDSL, VHDSL, etc), FTTH (Fibre to |
| | the Home, as in the National Broadband Rollout/NBN), any |
| | Telco managed network, and/or private utility networks (e.g., a |
| | Utility's SCADA network) or Business networks (e.g., MPLS |
| | or DDN/DDS)), and/or “proprietary” unique networks such as |
| | Mesh networks (802.14.5/ZigBee/6LowPAN/etc). |
| Service Provider | Entity providing customer service (e.g., a device vendor). In |
| | certain embodiments, a customer may register a device with a |
| | service provider, utilizing the Infrastructure Provider network |
| | for communications purposes. |
| Web Services | Application Layer Communications protocol, e.g., Web |
| Machine Interface | Services, HTTP/HTTPs, MQ, MQTT/MQTT-s, AMQP, XMPP |
| External Interface | and/or others. |
| Device or End-Device | A processing unit or control circuit, optionally with software or |
| | firmware, which performs at least one specific function, and |
| | which may support the delivery and/or execution of one or more |
| | applications. |
| Gateway | Device which contains integration and/or communication |
| | methods which may allow any combination of one or more of |
| | the following; forwarding of applications; forwarding of data; |
| | control of devices beyond the gateway; communication with |
| | applications devices beyond the gateway; and any standard |
| | network of device control functions. Forwarding functionality |
| | may include acting as an IP gateway or router, acting as a |
| | gateway or router between communication technologies, such |
| | as wired and/or wireless technologies (Ethernet, 3G, WIFI, |
| | ZigBee, and others) |
| WSDL/XSLT/ | The use of XML nomenclature is to be considered indicative of |
| XML/DTD/XSD/ | intent in expressing methods for transportable data formatting. |
| etc | The use of JSON, CSV, YML, or other formats not previously |
| | mentioned are not counter indicated and may be used in any |
| | combination when determining the individual embodiment of |
| | the disclosure. |
| Internet | May be used in two contexts: (1) as part of “internet protocol”, |
| | and as the noun “Internet” referring to the public network based |
| | on the internet protocol. |
| Integration Services | Integration Services acts as the “Broker” for receiving messages |
| Messaging Services | and requests, then forwarding the message (or storing for later |
| Transformation | forwarding) to recipients which may have registered interest in |
| Services | such messages, messages of certain types, messages from |
| | certain devices, or all messages. |
| | Messaging Services manages the reception and transmission of |
| | messages. Examples may include “Publish/Subscribe” |
| | methodology where modules “Subscribe” to services they want |
| | to receive messages for, and “Publish” messages to interested |
| | subscribers. In one example, the device may connect and |
| | Subscribe and/or Publish via 301 without a concentrator. |
| | Transformation Services applies transformation rules to |
| | partially or substantially alter message contents. The |
| | Transformation Services may be intended to accept a message |
| | in a known format, such as a binary message dump from a |
| | meter, and “Transform” it into a “common” format such as |
| | JSON or XML which can be used directly or indirectly by the |
| | customer/consumer/application/application services etc). |
| | Conversely, the Transformation Services may also transform a |
| | common format to a known format for delivery to a device |
| | which may subscribe to a particular format but be unable to |
| | receive and process messages in the “common” format. (e.g., |
| | due to message size). |

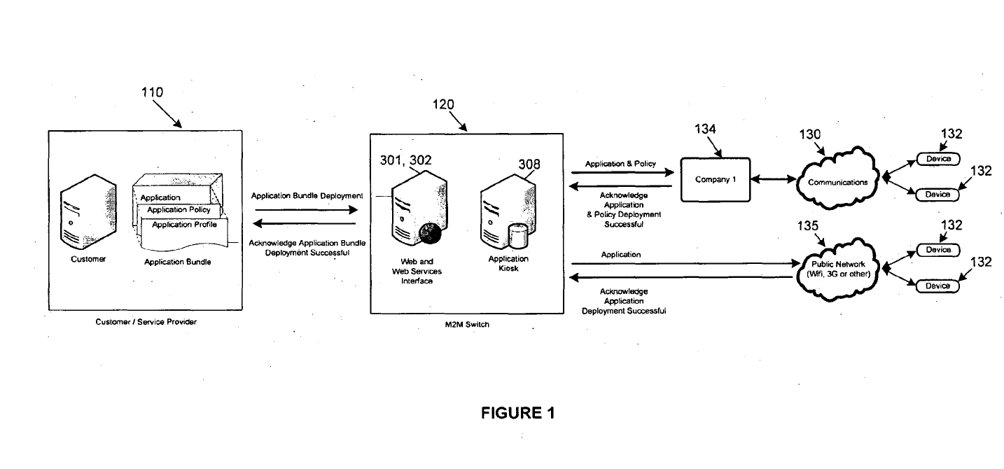

Certain exemplary embodiments are illustrated in FIG. 1. An integration computer system 120, as shown in FIG. 1, provides a user interface, such as a web interface (301) available via a web browser, a hand held or mobile electronic or telecommunications device, the interface may be a graphical display, one or more web pages, a command session (such as a command line interface using e.g., the Telnet protocol), and web service interface (302), an interface intended to enable a device such as a computer 110, computer application, web page or hand held device or device application of a customer or a service provider to connect to and communicate with the integration system 120 to select computer program applications stored on an application kiosk 308. As would be understood by a person of ordinary skill in the art, the kiosk could be a single computer or more than one computer configured to store applications. In exemplary embodiments, the kiosk may be implemented in a third party storage system. The selected applications may be deployed by the integration system 120 over an infrastructure provider's network 130 to customer premises equipment or devices 132. To achieve this, the integration system 120 may communicate either directly or indirectly with equipment 134, e.g. servers, firewalls, routers and network equipment of the infrastructure provider's network 130. Applications may be selected using the web interface 301 or as the result of a web services interface 302 request to deliver the application. For example, an existing application may request and identify an available application upgrade. The application kiosk 308 of the integration system 120 may be a database, provided by a database management system, such as Oracle DB or Microsoft SQL server, that may store and/or manage data about application and/or firmware files that are registered with the integration system 120 and are available to be deployed to devices 132. The application bundles may be stored in a cloud or at a third party location e.g. external to 110 or 120. The customer devices 132 may be a variety of forms of customer premises equipment (CPE) that can connect to a communications network 130, and the network 130 may include a home area network (HAN), a local area network (LAN) connected to the Internet, other public networks or combinations thereof. The devices 132 may be a utility meter, modem, base station, television or home appliance, security system, power relay, building control system, home and/or industrial automation systems, logistics management devices, passive monitoring devices, active monitoring devices, etc. The devices 132 may include support for one or more applications, and/or communicate with a device which supports one or more applications and/or a device which supports may firmware and/or configuration (e.g., in certain embodiments, the device may be a microengine (FME) device as discussed in International Patent Publication No. WO2006/000033). If the device 132 does not include processing circuitry able to receive application code, it may need to communicate with a device, such as a device which supports one or more applications, that is able to receive the code.

In certain applications, applications registered and validated with the application kiosk 308 are part of an application bundle for a computer program application. An application bundle may include any combination of one or more of the following components:
(a) Application policy. A configuration data file, such as an XML file, including sets of configuration settings that apply to the application for different environments, such as network, location, country, etc. The configuration data may include, for example, customer specific data, billing data, permission and/or security data. The policy may be protected, controlled and/or edited by the integration system 120.
(b) Application profile. A services definition data file, such as a WSDL file, including application program interface (API) and/or transformation rules for the application. The API rules may include API commands that are available as part of the application for a wide variety of devices which support profiles such as device 132. The profile may define the commands which are and are not available for the different types of devices 132. In certain applications, the profile may indicate and/or describe which unique commands are available for a unique or specific type or class of devices 132. The application profile may use the web services interface 302 and a transformation service 303 of the integration system 120 to define the communications between the application and the customer/service provider 110.
(c) Application code. The executable binary code of the application for devices 132 which support one or more applications. In certain applications the code may include security features such as application signature, access control and/or permission data.
(d) Application Services code. The executable binary code developed using C, C#, Java, Ruby, Python or any other programming language, which may be executed on the integration system 120. The application services code may provide one or more of the following; (a) support the device and/or the application on the device (b) providing a human interface, for example Web Interface, Telnet interface (c) providing a machine interface, for example Web Services Interface, XML/HTTP/SOAP/REST/JSON or any combination of these or any other format required to support the device or application on the device via the machine interface.
(e) Other files, where and as required, example may include application or device configuration files, menu information and help files.

For customer devices that do not sufficiently support the ability to receive and execute an application, the integration system can deploy and/or store an application bundle in the application kiosk 308 that includes the one or more of the components listed herein. For customer devices 132, the integration system can deploy and/or store an application bundle, for example, directly on the device and/or in the application kiosk 308 that may include any combination of one or more of the following similar components:
(a) A configuration data file that may include configuration settings that apply to the application for the different environments.
(b) Device profile. A services definition data file for the device that is similar to the application profile discussed herein. The device profile may also include a services definition data files, such as a WSDL file, including API and/or transformation rules for the application.
(c) Device Firmware. This is executable binary code for the device 132 in order to execute the application.
(d) Other files, where and as required, example may include device configuration files, customer information, product information, etc.

Published APIs of applications may be made available to customers and service providers 110 through the web services interface 302 of the integration system 120 to control and/or interact with the application deployed to a customer device 132.

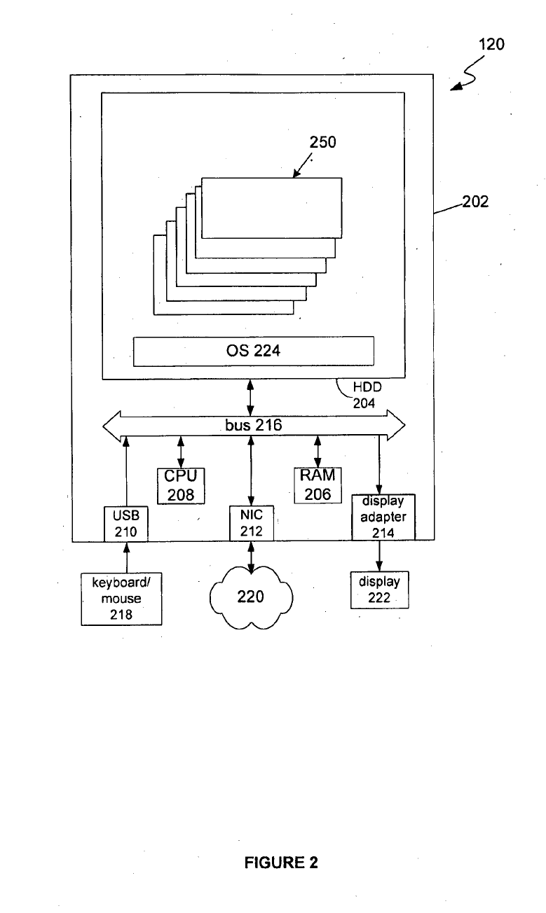

Certain exemplary embodiments are illustrated in FIG. 2. The integration computer system 120, as shown in FIG. 2, may be based on a standard computer 202, such as a 32 or 64 bit Intel architecture computer produced by Lenovo Corporation, IBM Corporation, or Apple Inc. The processes executed by the computer system 202 may be defined and controlled by computer program instruction code and data of software components or modules 250 stored on non-volatile (e.g. hard disk) storage 204 of the computer 202. In certain applications, the processes executed by the computer system 202 may be defined and/or controlled in whole or in part by computer program instruction code and/or data of software components and/or modules 250 stored on non-volatile (e.g. hard disk) storage 204 of the computer 202. The processes performed by the modules 250 can, alternatively, be performed by firmware stored in read only memory (ROM) or at least in part by dedicated hardware circuits of the computer 202, such as application specific integrated circuits (ASICs) and/or field programmable gate arrays (FPGAs).

In certain applications, the computer 202 may include random access memory (RAM) 206, at least one microprocessor 208, and external interfaces 210, 212, 214 that are connected by e.g., a system bus 216. The external interfaces may include universal serial bus (USB) interfaces 210, a network interface connector (NIC) 212, and a display adapter 214. The USB interfaces 210 may be connected to input/output devices, such as a keyboard and mouse 218. The display adapter 214 may be connected to a display device, such as an LCD display screen 222. The NIC 212 enables the computer 202 to connect to a communications network 220. The network 220 may include one or a combination of existing networks 130, such as a LAN, WAN, the PSTN, the Internet, mobile cellular telephone networks, etc. The computer 202 includes an operating system (OS) 224, such as Microsoft Windows, Mac OSX or Linux. The modules 250 may run on the OS 224, and include program code written using languages such as C, C++, Python, Ruby, C#, etc, without impact to operation or function.

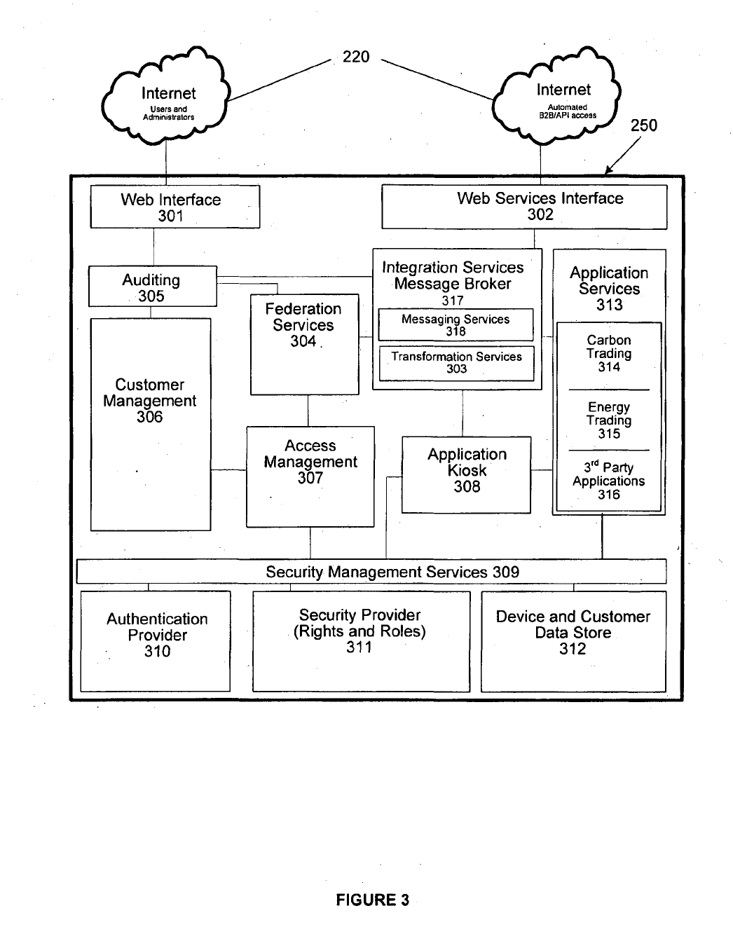

FIG. 3 illustrates certain exemplary embodiments. The modules 250 of the integration system 120 may include, as shown in FIG. 3, a web interface 301 supporting browser based access and administration. One function of the web interface 301 may be for the management and administration of entities within the integration system 120, such as adding and/or removing consumers, providers, and/or devices 132. A web services interface 302, such as provided by Apache Tomcat5, WS02 or Oracle WebLogic products, may be used to support WSDL and application and/or device profile based communications for API based application access and/or administration. The web services 302 interface may provide automated deployment and/or management of applications. Control of applications in customer devices 132 which support one or more applications may be expressed by providing the application interfaces described in the profile service definition components available to be viewed and selected by users accessing the web interface 301. Features of the applications may be expressed as part of the profiles for the applications and/or made available as a service to customers.

In certain applications, external requests via the web services 302 may be managed by the Integration Servers Message Broker 317, which coordinates authentication via a federation services framework 304. Authentication can also be coordinated by transformation via the Transformation services 303 and delivery of requests to Application services 313 or to an external customer or device via web services 302. In certain embodiments, the federation services framework 304 may help ensure that requests and/or transactions are logged via an auditing module 305 for billing and/or security purposes. The federation services module 304 may manage and coordinate an access management module 307 for requests. In certain applications, the federation services module 304 may manage and/or coordinate an access management module 307 and a transformation services module 303 for a substantial portion of the requests or all of the requests. In certain applications, the Integration Services Message Broker 317 may manage and/or coordinate a Federation Services module 304 and/or Messaging Services 318 and/or Transformation services 303 and/or Application Services 313 for a substantial portion of the requests.

In certain applications, the access management module 307 may be used to validate the web services interface request by a user using a security management services layer 309. Once this has been completed, information about the authenticated user may be used to identify end devices and/or policies using, for example, a customer management module 306. Information discovered through the customer management module 306 may be logged for security purposes.

In certain applications, a set of security management services 309, may be used to handle the authentication of computers, customers and/or devices. An authentication provider 310, as an example, may be an internal or external provider of security information, such as one or a combination of; Microsoft Active Directory Services, RADIUS, LDAP, Database, etc.. Once authentication information has been obtained a security provider 311, utilizing a database of access control information identifies the access available to the user, which functions may be performed, and which end devices 132 may be interacted with. In certain applications, once authentication information has been obtained a security provider 311, utilizing a database of access control information may identify the access available to the user, which functions may be performed, which end devices 132 may be interacted with, or combinations thereof.

A device and customer data store 312 is a data repository used to persist information about the web services interface 302 requests and current or outstanding transactions. It also may maintain data about customers, users, providers and/or devices 132 required by the integration system 120.

Web services interface requests may be validated and transformed by the transformation services module 303 using the application or device profile and application policy or configuration data contained in the application kiosk 308. Once an application has been deployed on or for a device 132, with the application code and policy or configuration, the application or device profile may be used by transformation services 303.

In certain embodiments, the transformation services component 303 may be a data processor providing translation between high level web services interface 302 requests, which may be in a combination of SOAP, HTTPS, XML, and WSDL, and the deployed application. Web services interface requests may contain high level XML requests incorporating API commands such as ‘Light On’ and ‘Request Meter Data’ with arguments expressed as high level data types and enumerations. The deployed applications may expect the requests in a variety of formats including XML, CSV, ASCII or packet binary data structures. The transformation services component 303 implements the transformation between the incoming XML request, and the application specific request format as defined in the application profile and/or device. The transformation services component 303 may also perform the inverse transformation from application specific response format to a high level XML format suitable for high level web services interface 302 response. A transformation may involve web services schema validation (XSD), translation using XSLT, application schema validation (XSD) or combinations thereof.

In certain applications, the transformation services component 303 may be responsible for the integration of the web services interface requests 302 with each, or a substantial number, of the individual devices 132 and applications or devices 132 that can communicate with the integration system 120. In certain embodiments, devices or applications managed and supported by the system 120 may require a device or application profile 404 to be retrieved, as discussed herein. The profile for a device or application may include data describing the externally accessible web services interfaces (WSDL), a schema (XSD) used to verify 406 incoming XML requests and either a set of transformation rules (XSLT) or a code module (plug-in) used to perform message transformation processing, executed by respective message processors 408 and 410. XML requests are received via the web server's interface 302. The request may be received directly, or indirectly, from a device and/or application, or via the web interface 301, and may be destined for one or more end-devices. After successfully being authenticated by federation services 304, the requests may be processed by the transformation manager 402. The transformation manager 402 retrieves the relevant application profile 404 from the application kiosk 308.

For each, or a substantial number, of target device, the message target may be selected 412, and the message processing continues.

The Message Target Selection 412 determines the intended recipient of a message or request. The intended recipient, when known to contain an application, allows the application profile to be retrieved 404 from the application kiosk 308.

Where the application profile contains an XSD (XML Schema Dictionary) or equivalent, the message is validated 406.

Where the application profile contains an XSLT (XML Stylesheet Language Transformation) or equivalent, the message is transformed 408.

Where the application profile contains executable transformation code, the transformation may be performed via execution of the transformation code 410.

The message, after optional validation and transformation, may then packaged for delivery 414 as a response via the web services interface 302.

Processing then continues with the next available message target, allowing each, or a substantial number of, message destination to apply unique transformation and validation rules prior to delivery.

In certain applications, the transformation services component 303 also may support remote access to devices and/or their applications as the transformation manager 402 supports a process referred to as ‘pass-through’ that allows a user, e.g. a device owner, to issue commands, and/or send or receive data directly (or indirectly) to and from a remote device without performing additional transformation or plug-in processing. Pass-through is available when the device profile specifies a communications mechanism (i.e. protocol) and a pass-through capability. When requested, via a web services request 302, the pass-through capability may be activated through the establishment of a secure communications channel between the external equipment 110 of the user, and the device 132 itself. In the event that a device cannot be adequately supported via a web services interface and transformation or plug-in, ‘pass through’ allows user equipment 110 to issue commands which are delivered intact to the remote device 132.

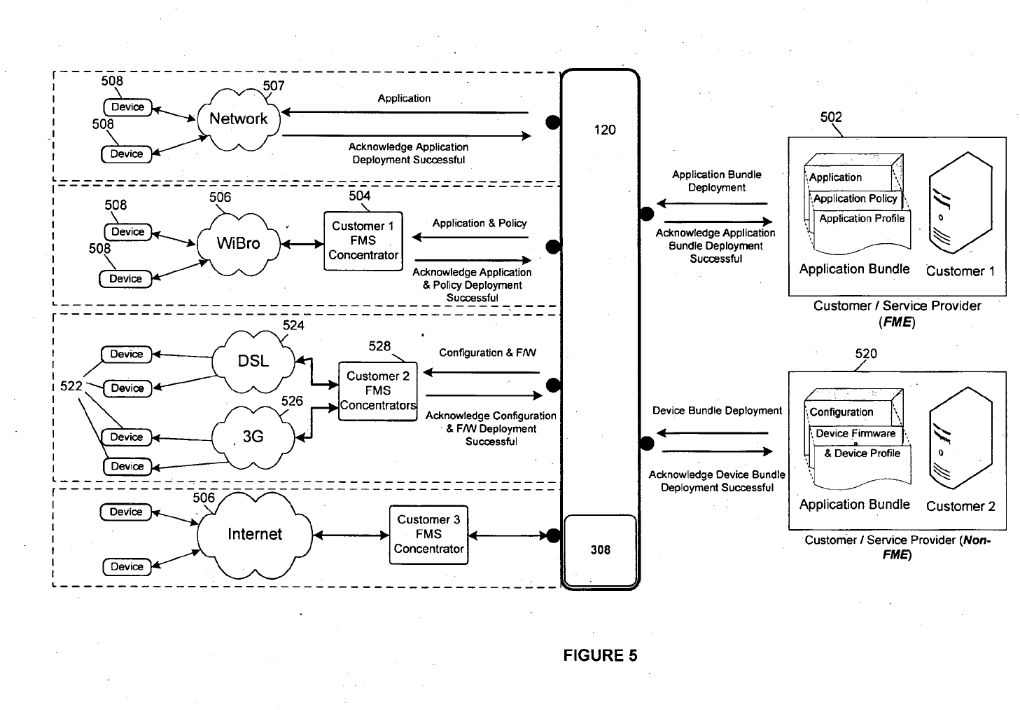

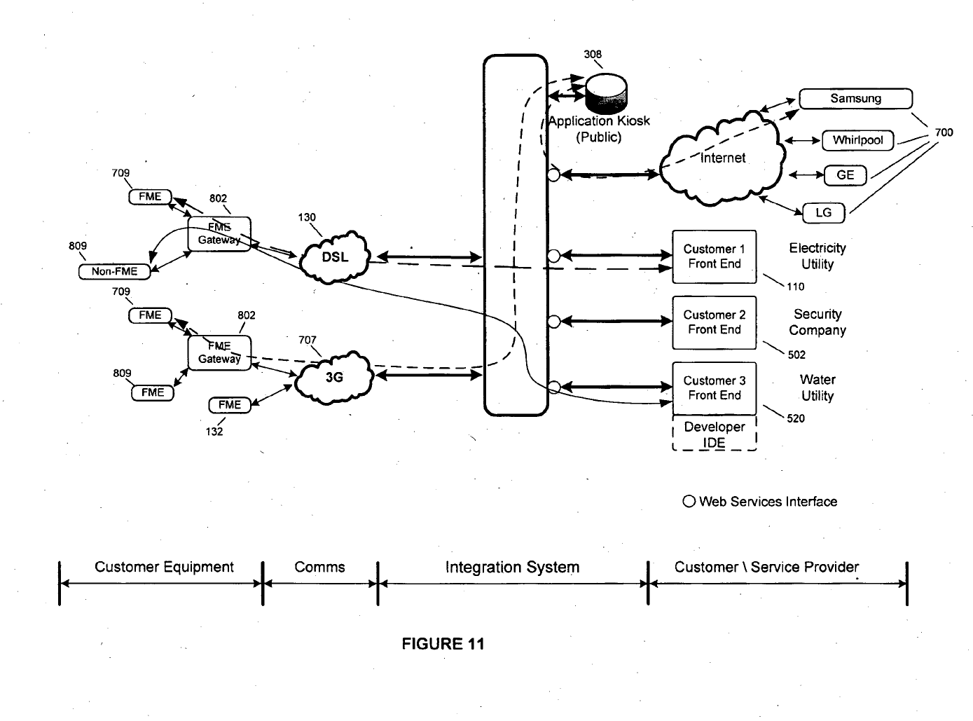

The flexibility of the integration system 120 is illustrated in FIG. 5, according to certain embodiments. As illustrated in FIG. 5, service providers are able to use computer equipment 502, 520 to utilize the integration system 120, through the external interfaces (such as a web interface 301, or a machine interface such as web services infrastructure 302). A first service provider 502 deploys application bundles for devices which support one or more applications and/or policies, or other devices able to accept the application bundle, including application code, application policy, application profiles or combinations thereof. The application codes and policies may be delivered directly via a network 507 such as internet 506 or a managed telecommunications network as described in FIG. 11 providing DSL 130 or 3G 707 services.

The application codes and policies may be downloaded using a first FMS concentrator 504 which communicates with a communications network such as the WiBro communications network 506 for delivery to devices 508.

The devices 508 may allow direct communication with the integration system 102, or indirect communication with the integration system 102 when used with an intermediate networking device such as one or more gateway 802 devices or FMS concentrator systems 504

In certain embodiments, a second service provider may use their computer equipment 520 to deploy an application bundle on the integration system 120 that includes configuration code and/or device firmware code and/or device profile or combinations thereof. The configuration data and firmware code for the bundle may be downloaded to devices 522 which may support deployment of an application bundle, over DSL and/or 3G networks 524 and 526 using a second FMS concentrator 528. The application and device profiles stored in the integration system 120 enables the service providers 502 and 520 to send messages and/or receive responses directly (or indirectly) from the respective devices 508 and 522 and also deploy a wide variety of applications using the web services interface 302 of the integration system 120.

Devices 522, may communicate with the service provider 520 through the use of a Concentrator 528.

In certain embodiments, the integration services component 317 may use the application kiosk 308 as the source of device and application profile data. Supported application profiles may include one or more of the following:
(a) Application profile details for devices which support one or more applications, which may including Web Services based schema (XSD), transformation (XSLT) and interface specification (WSDL) details.
(b) Device profile details for devices supporting operation without an application. The device profiles contain schema (XSD), transformation (XSLT) interface specification (WSDL) similar to the Device Application profile details, with optional device specific properties which are unique, or substantially unique, to devices which operation without an Application, including but not restricted to hardware features and/or abilities and/or remote firmware or configuration upgrade support details.
(c) Communications details and optional “plug-in” for devices which do not natively support the integration system communication protocols. The “plug-in” may include a software code module designed to apply unique device transformations and/or manage physical communications, such as a gateway 802. The results of the transformation are delivered directly (or indirectly) to the device without further interpretation.

In certain embodiments, application and device profiles may include one or more of the following:
(i) WSDL, Web Services Definition Language file.
The WSDL file contains a series of instructions which define the set of interfaces accessible to the web services interface 302 users. The example WSDL file provided in the accompanying Appendix demonstrates the definition of am2m.sendCommand web service API. The “sendCommand” service may be invoked externally by customers in order to deliver XML commands to a device 132.
(ii) XSD, XML Schema Definition file.
The XSD file contains the schema definition used to check and/or validate the incoming XML web request or message. Once a command, such as “sendCommand” has been used by a customer to send the XML message, the message itself may be verified. Using the XSD file, the XML message may be examined. If the message is unable to correctly validate according to the schema definition, an error is returned to the user. The example XSD file provided in the accompanying Appendix demonstrates the schema for a number of commands related to Lighting control.
(iii) XSLT, Extensible Stylesheet Language Transformation.
The XSLT file contains a series of code rules used and executed for locating and/or transforming data in the XML message using a message transformation processor 408. The end device 132 may require a specific data format for commands. In certain applications, the end device 132 may require a specific data format for all commands. This data format may be very compact and is often in binary. The example XSLT file provided in the accompanying Appendix demonstrates a conversion between the XSD defined message format, and the application specific binary message format.
(iv) XML, Extensible Markup Language.
The XML format may be used for message processing, as well as the format for support files. In certain applications the XML format is used for all message processing, as well as the format for all support files. The example XML requests in the Appendix demonstrate the use of XML, with the appropriate xmlns qualifiers to identify the application namespace, specifying example commands to the device application, according to certain embodiments. The first example provides a numbered service (0x95) which relates to Flashing a light a specific number of times, and the second example provides a numbered service (0xA1) which relates to setting an automation schedule.

In certain embodiments, the result of transformation services 303 requests may be delivered to the infrastructure provider for delivery to a specific application, or to multiple applications. In addition, the result of a web services 302 request transformation may be delivered internally to an application services component 313. Application features provided by the application services 313 module may vary depending on the operator of the integration system 120. For example, application services 313 may include one or more of the following:
(i) Carbon trading 314. A device application is able to report at predetermined intervals carbon trading data (e.g., representing usage, carbon credits credit and debit details, time of use, etc) to the integration system 120 via an API of application services 313. Carbon trading may be executed by the integration system 120, or through an authorised trading party having access to the integration system 120 and the data of carbon trading services 314.
(ii) Energy trading 315. A device application is able to report at predetermined intervals energy trading data (e.g., representing examples include usage, cost, time of use, tariff, tier) to the integration system 120 via an API of application services 313. Trading may be executed by the integration system 120, or through an authorised trading party having access to the integration system 120 and the data of energy trading services 315.
(iii) Customer or 3^{rd} Party Application 317 delivered as part of the Application Bundle, invoked by the integration system to operate on data or messages, for example generated by the application binary code in the device, and/or generated based on device function, device state or device usage.

Other applications services are also contemplated. For example, a logistics trading service in which a device application is able to respond and accept device requests based on criteria such as distance and allocated time allowed. Trading may be executed by the integration system 120, or through an authorised trading party having access to the integration system 120 and the data of logistics trading services. The Device 132 can auction the cost of moving from one location to another.

In certain embodiments, the functionality of the device 132 may be determined and/or defined by the applications on the device 132. In certain applications, the functionality of the device 132 may be determined and/or defined at least in part by the applications on the device 132. The application code, policy, and/or device firmware may be versioned with a release version and/or, and a platform version and/or identifier which may assist in identifying the hardware used by the device 132.

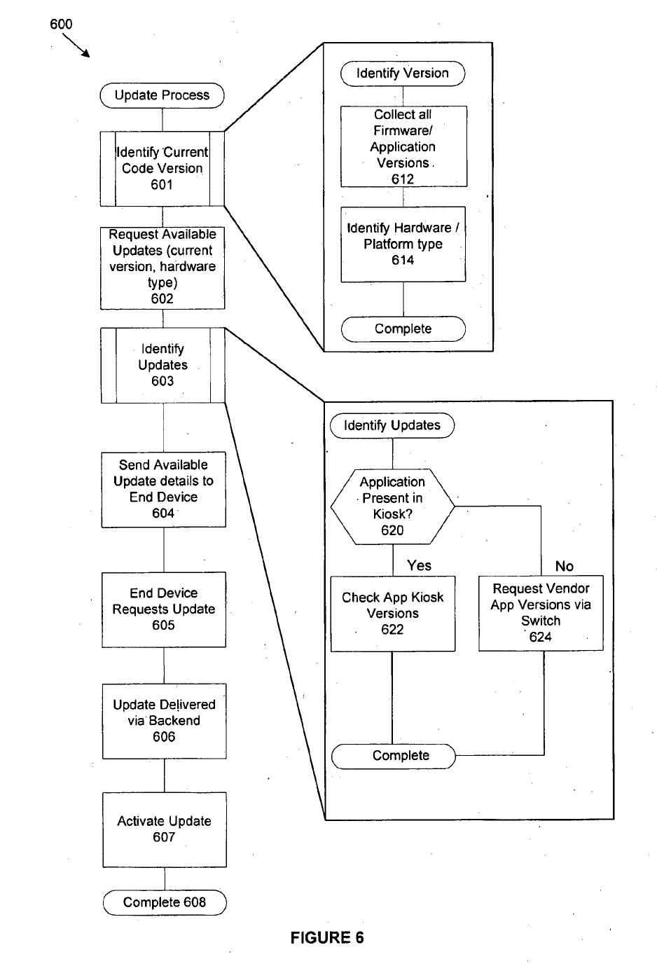

In certain embodiments, applications (code and/or policy) and/or firmware and/or configuration on a device 132 may be updated using the integration system 120 by executing an exemplary update process 600, as shown in FIG. 6. Other updating may also be carried out by, for example, by an external update process located at a remote location to integration system 120. In the exemplary illustration shown in FIG. 6, the update process is executed:
(i) On device startup, when the device 132 establishes network communication with the system 120;
(ii) According to a predetermined and configurable schedule, which allows for available updates to be identified and requested during normal operation; and/or
(iii) During error recovery. In the event than an unusual condition is detected, for example an application exception, the update process may be triggered to establish if an update is available.

In certain embodiments, the update process may commence with the firmware of the device collecting the current version of one or more components, including, for example, firmware, application code and/or policy and identifying the hardware type (platform type). For example, as illustrated in FIG. 6, the update process 600 commences with the firmware of the device 132 collecting the current version of all, or substantially all, components (step 601), including firmware, application code and policy (612) and identifying the unique hardware type (platform type) (614). The device 132 may send a request available updates message with the collected identification data to the infrastructure service provider (602). The message causes the infrastructure provider equipment 134 to initiate an identify updates process (603) in the integration system 120. In certain embodiments, known application and firmware updates may be accessed from the Application Kiosk 308 (620, 622) or, if the application or platform type is unknown, the request for known updates may be sent by the integration system 120, using the existing web services interfaces 302, to appropriate hardware vendors for firmware updates, and/or to service providers for application code and policy updates (624). Details on the update data may be delivered (604) to the device 132. The device 132 schedules an update request (605) with the system 120. The system 120 delivers the update (606) based on the schedule as appropriate. The update is activated (607) such as by a device restart or an application restart as required or desired.

Application and/or application bundle delivery can be immediate or delayed, this may be achieved by the selection of an application or application bundle from the application kiosk 308 and manually or automatically forwarding the application or application bundle, including application code and application policy to the infrastructure provider for final application deployment and activation. The application profile remains with the integration system 120. There may be a cost associated with the request of a policy from integration system 120 and/or delivery an application or application bundle to device 132.

In certain embodiments, the integration system 120 supports any combination of one or more of the following:
(i) Registration of infrastructure providers and customers with the system 120.
(ii) Registration of devices based on unique identification data (such as serial number, hardware identifier, device identifier or unique barcode information).
(iii) Installation of application bundles into the application kiosk 308. An application bundle may include the code of application executable file, the application profile (metadata describing application configuration and data formats used to derive XML, DTD, XSLT and WSDL code for web services) and the application policy data supporting access control and other files as required to support application configuration and usage.
(iv) Automated discovery and/or configuration of customer devices
(v) Deployment of applications to customer devices.
(vi) Assignment and/or revocation of customer access to devices and/or applications.
(vii) A multi-tenanted mode on devices, where a device operates in a mode where a number of applications are able to run on the device, using its virtual machine and/or OS and different customers (tenants) are able to address or access different applications or instances of applications.
(viii) Removal of applications and/or application templates from the application kiosk 308.
(ix) Audit and/or logging and/or error handling of at least substantial portion of the transactions or all transactions.
(x) Application services which may be provided by at least a substantial portion of the applications or all the applications. Examples include, but are not limited to, energy trading, registration of carbon credits, carbon credit trading, logistics trading to obtain the most cost effective logistics transfer or combinations thereof, and video and/or audio management, delivery and control. A device application may display and control video and/or audio.

A device may, in the process of automated discovery (iv above), make available to the integration system information pertaining partially or wholly to the application executable code, application profile and/or application policy.

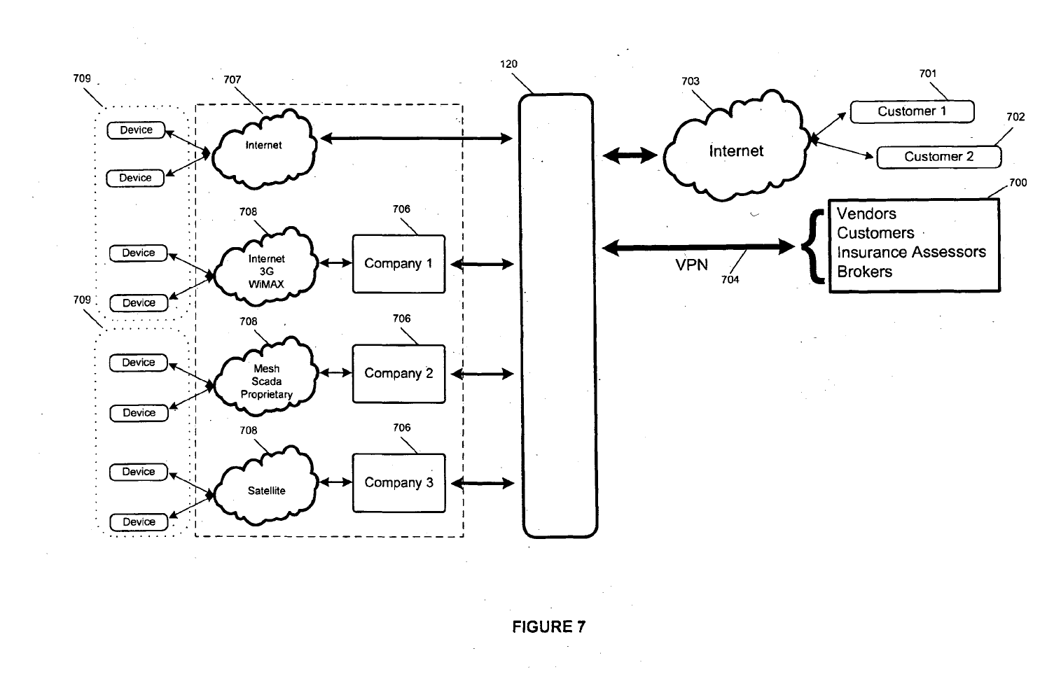

In certain embodiments, the integration system 120 provides a form of cross domain switching, in that it is able to give users 700, 701, 702 access to customer devices 709 connected to different infrastructure provider networks, as shown in FIG. 7. A consumer or customer 700, 701, 702, once connected to the integration system 120 via the Internet 703 or a VPN 704, may deploy and interact with applications across all providers networks 705, 706, 707, 708. In certain embodiments, A consumer or customer once connected to the integration system via the Internet or a VPN 704, may deploy and interact with applications across a substantial portion of the providers networks.

Control over the application layer in the device may be provided by integration system 120 to the customers 700, 701, 702. Other ways of providing control over the application layer in the device may be provided by, for example, direct access to the device 709 or network 705, 706, 707, 708. In certain applications, control of the physical end device 709 remains under the direct (or indirect) management of the infrastructure provider's equipment 705, 706.

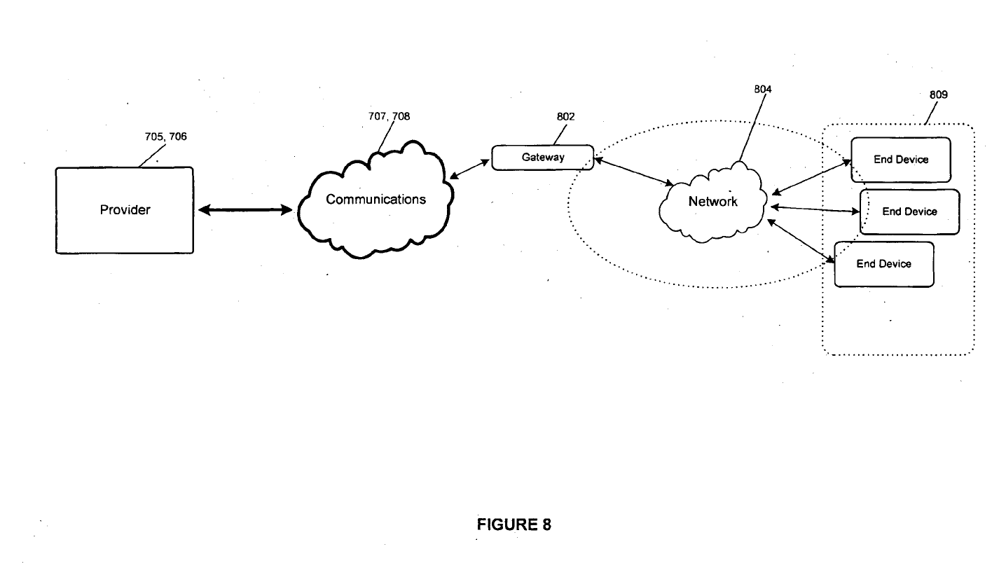

In certain embodiments, where a customer end device 709 is an intelligent gateway 802, as shown in FIG. 8, the gateway may be completely owned and/or managed as part of the infrastructure providers network 707, 708. In certain applications, the gateway may be at least partially owned and/or managed as part of the infrastructure providers network. The gateway 802, can be used to extend the reach of the customer 700, 701, 702 beyond the initially deployed infrastructure and gateway devices, to support mobile devices (which may travel between provider networks), low-power wireless devices, such as customer devices 809 in a HAN 804, which are unable to be directly supported by the infrastructure providers network 707, 708 or combinations thereof.

The gateway 802 may support the forwarding of a device firmware and/or configuration and/or applications or application requests between an end device 809 and the provider 705, 706, and the forwarding of component updates, such as applications, application policies and/or firmware for the end device 709 or combinations thereof. This support may be provided by a standard gateway, e.g., simply by its firmware, or by and intelligent gateway which may support one or more applications.

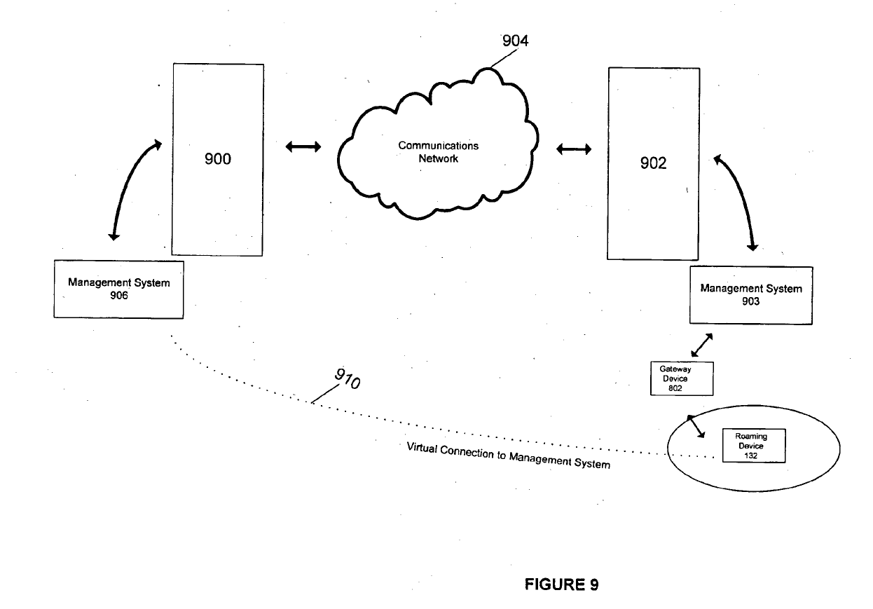

In certain embodiments, a customer device 132 may be permitted to roam between different communication networks and/or jurisdictions, for example if it is installed on a shipping container. If the device 132 is able to roam, between the communication boundaries of two different integration systems 900 and 902, as shown in FIG. 9, the device 132 is still able to communicate with the intelligent gateway device 802 within range. The gateway device 802 forwards communications from the device 132 via an infrastructure provider's management system 903 to an integration system 902. The integration system 902 is able to communicate via a communications network 904 to another integration system 900 that communicates with the management system 906 that the device 132 normally communicates with in order to obtain security and/or authentication data from the management system 906.

In certain embodiments, a roaming end device 132 connects to a nearby gateway device 802, and first attempts to authenticate. The management system 903 identifies the device 132 as a foreign device with foreign security credentials, and forwards a foreign device authentication request to the integration system 902. The integration system 900, 902, 120 using a mechanism for contacting other integration systems, such as an established group of agreed neighbour systems 900, 902, 120, participating and communicating via a communications network 904, which may be, for example, an Internet VP and/or a set of private networks. The systems 900, 902, 120 may identify a number of devices 132 which may roam. Using the data about the integration system neighbours and roaming device 132 identities, the integration system 902 forwards the device authentication request to the integration system 900, which in turn, reports the request to its management system 906 to complete authentication and establish a virtual connection 910 between the roaming device 132 and the management system 906. The virtual connection 910 allows for continued communication between the infrastructure provider's management system 906 and the roaming device 132 until the device 132 returns to the jurisdiction and range of the management system 906, or attempts to connect via another gateway device 802.

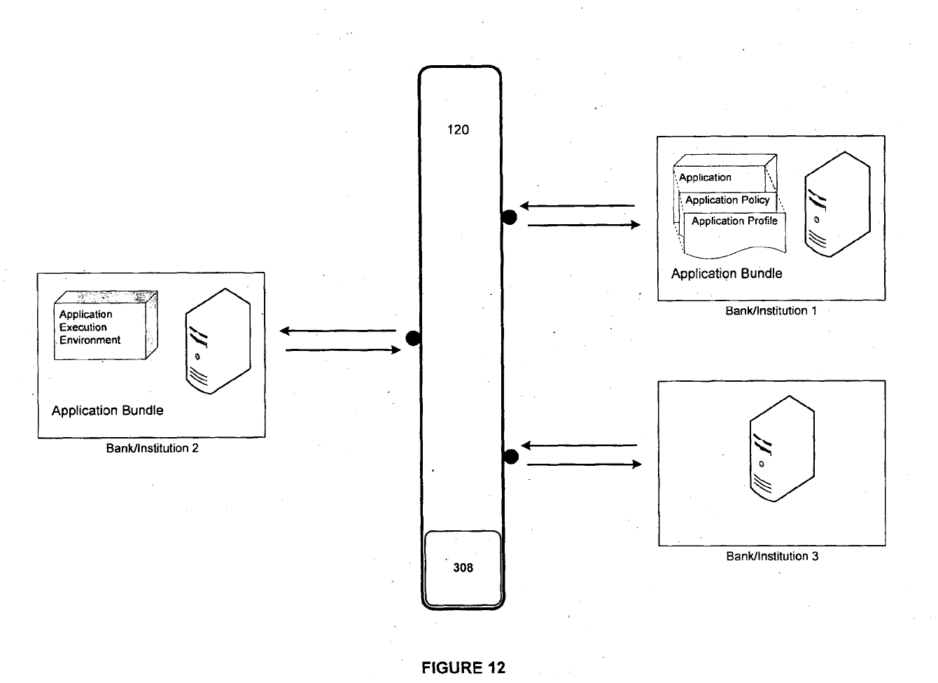

FIG. 12 is a block diagram of an integration system interconnecting a plurality of institutions (e.g., banks), according to certain embodiments. FIG. 12 illustrates an exemplary use of the integration system where an institution wants to provide particular services to its customers. For example, in an exemplary embodiment, bank/institution 1 may desire data or services from Bank 2; Bank 2 may be providing services to external parties such as Banks 1 & 3; and Bank 3 may be utilizing data or services from Bank 2 as established by Bank 1.

Accordingly, Bank 1, (a financial institution and wishes to provide a service to its customers (individuals, institutions and other banks, such as Bank 3)) may create an application bundle containing an application (code, executable), an application policy (access requirements for example) and an application profile (transformation rules for example). The application may then be deployed to any device or Application Execution Environment which supports the application.

The application, once installed in the target application environment, may perform the business functions it was designed for, with access to the resources allowed by bank 2.

For example, if Bank 1 required a daily report of outstanding currency transfers for example, the traditional path would be to request a report to be generated by Bank 2, and forwarded, electronically or otherwise, to Bank 1. If Bank 3 required the same report, it may require a separate request be sent and a separate report generated.

The approach made available by the integration system would allow Bank 1 to develop and deploy an application to the Application Execution Environment within Bank 2. The commands and software interfaces would be published to the integration system. Once complete the commands and software interfaces would be available to Bank 1 or Bank 3 to request and generate the required data and reports.

Therefore, Bank 3 may contact the integration system, and “discover” the available commands and software interfaces, either directly from the integration system (and/or application kiosk, for example) or by identifying Bank 2 and completing a “discovery” allowing the commands and software interfaces available from Bank 2 (which may also include those from the Bank 1 (application) and could include others—Bank 4, 5, 6, 7, 8 etc. to be known to Bank 3. The interface may be web services 302 for example and the commands may describe the actions available via the application.

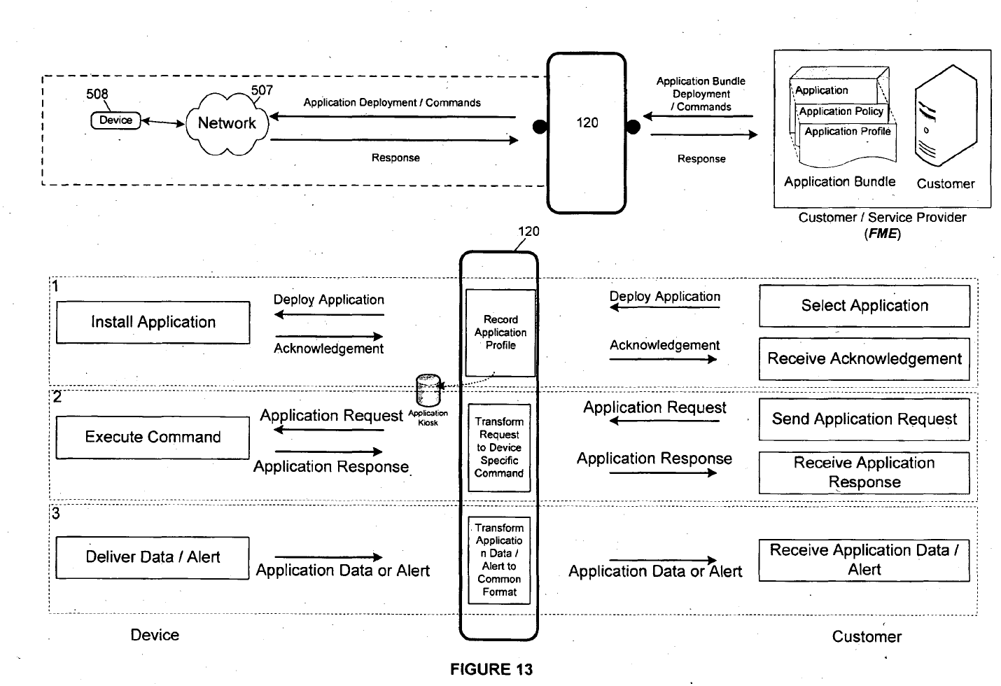

FIG. 13 is a block diagram of an integration system for handling various aspects of application processing in accordance with certain embodiments. In FIG. 13, the customer may be responsible for developing and deploying an application bundle (e.g., code, policy and profile); the device/end-device is a computer or server with the appropriate software providing an application execution environment for applications.

In the case of application deployment, if the customer selects an application, either stored locally, or via an Application Kiosk selection, the customer initiates an application deployment, resulting in a “Deploy Application” request being generated. If the application is located locally, the application is delivered with the request. If the application is located in the integration system, such as within an Application Kiosk, the application is extracted by the integration system and attached to the request.

The application profile is recorded against that device for all future communications.

After application deployment, confirmation is sent, first from the device to the integration system, then from the integration system to the customer.

In the case of an application request, the customer sends application request to the device via the integration system. The integration system accepts the request. A transformation is performed for any part of the request which requires transformation. The final message is then delivered to the device. Transformation may include converting XML to JSON or BIN. Or the addition of device specific fields to the application request.

The device delivers an application response to the integration system. The integration system will perform the reverse transformation where required, and deliver the application response to the customer. Reverse transformations may include converting JSON or BIN to XML for example, or the adding or removal of message fields as required.

In the case of application alert or unsolicited data, the device, on a schedule, or when a specific condition is met, or when a trigger is encountered, may send data or an alert to the customer. The data or alert is delivered to the integration system. The integration system may perform transformation on the application data or alert, depending upon the source of the message, the format, and the information available to the integration system.

The integration system will then forward the application data or alert to the customer.

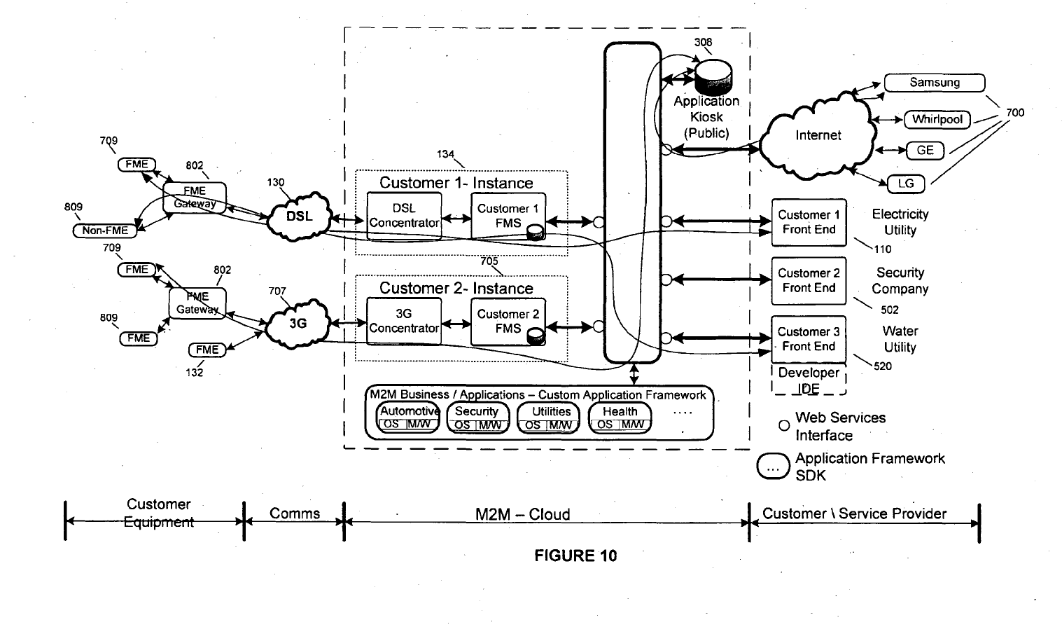

As will be apparent from the above, the integration system is able to support a wide variety of customer premises devices 132, 709, 809 and integrate them for deployment and control with a wide variety of infrastructure, service providers and customer systems 110, 502, 520 and 700, as shown in for example, FIGS. 10 and 11.

Additionally, the disclosure has been described with reference to particular embodiments. However, it will be readily apparent to those skilled in the art that it is possible to embody the disclosure in specific forms other than those of the embodiments described above. The embodiments are merely illustrative and should not be considered restrictive. The scope of the disclosure is given by the appended claims, rather than the preceding description, and variations and equivalents that fall within the range of the claims are intended to be embraced therein.

### APPENDIX

Example WSDL File

<?xml version=“1.0” encoding=“UTF-8”?>
<wsdl:definitions xmlns:wsdl=“http://schemas.xmlsoap.org/wsdl/”
xmlns:soap=“http://schemas.xmlsoap.org/wsdl/soap/” xmlns:http=“http://schemas.xmlsoap.org/wsdl/http/”
xmlns:xs=“http://www.w3.org/2001/XMLSchema”
xmlns:soapenc=“http://schemas.xmlsoap.org/soap/encoding/”
xmlns:mime=“http://schemas.xmlsoap.org/wsdl/mime/” xmlns:xsi=“http://www.w3.org/2001/XMLSchema-
instance” xmlns:tns=“m2m.sendCommand” targetNamespace=“m2m.sendCommand”>

<wsdl:types>

<xs:schema xmlns:xsi=“http://www.w3.org/2001/XMLSchema”

targetNamespace=“m2m.sendCommand” elementFormDefault=“qualified”
attributeFormDefault=“unqualified”/>

</wsdl:types>
<wsdl:message name=“applicationRequest”>

<wsdl:part name=“parameter” type=“xs:string”/>

</wsdl:message>
<wsdl:message name=“applicationResponse”>

<wsdl:part name=“parameter” type=“xs:string”/>

</wsdl:message>
<wsdl:portType name=“FMSPortType”>

<wsdl:operation name=“FMSApplication”>

<wsdl:input name=“applicationRequestMessage”

message=“tns:applicationRequest”/>

<wsdl:output name=“applicationResponseMessage”

message=“tns:applicationResponse”/>

</wsdl:operation>

</wsdl:portType>
<wsdl:binding name=“FMSBinding” type=“tns:FMSPortType”>

<soap:binding style=“document” transport=“http://schemas.xmlsoap.org/soap/http”/>
<wsdl:operation name=“FMSApplication”>

<soap:operation soapAction=“urn:#NewOperation”/>
<wsdl:input>

<soap:body use=“literal”/>

</wsdl:input>
<wsdl:output>

<soap:body use=“literal”/>

</wsdl:output>

</wsdl:operation>

</wsdl:binding>
<wsdl:service name=“FMSApplication”>

<wsdl:port name=“FMSPort” binding=“tns:FMSBinding”>

<soap:address location=“No Target Address”/>

</wsdl:port>

</wsdl:service>

</wsdl:definitions>

Example XSD File

<?xml version=“1.0” encoding=“UTF-8”?>
<!-- edited with XMLSpy v2011 rel. 2 sp1 (http://www.altova.com) by Adam (ANATAS) -->
<xs:schema xmlns:sl=“acmepower.app0001.app” xmlns:xs=“http://www.w3.org/2001/XMLSchema”
targetNamespace=“acmepower.app0001.app” elementFormDefault=“qualified”
attributeFormDefault=“unqualified”>

<xs:element name=“StreetLightApplication”>

<xs:annotation>

<xs:documentation>application providing streetlight

functions</xs:documentation>

</xs:annotation>
<xs:complexType>

<xs:sequence>

<xs:element name=“MessageID”>

<xs:simpleType>

<xs:restriction base=“xs:string”>

<xs:length value=“14”/>

</xs:restriction>

</xs:simpleType>

</xs:element>
<xs:element name=“CmdID”>

<xs:simpleType>

<xs:restriction base=“xs:string”>

<xs:length value=“14”/>

</xs:restriction>

</xs:simpleType>

</xs:element>
<xs:element name=“Cmd”>

<xs:simpleType>

<xs:restriction base=“xs:string”>

<xs:length value=“2”/>
<xs:enumeration value=“95”/>
<xs:enumeration value=“96”/>
<xs:enumeration value=“97”/>

</xs:restriction>

</xs:simpleType>

</xs:element>
<xs:element name=“Flashes” minOccurs=“0”>

<xs:simpleType>

<xs:restriction base=“xs:int”>

<xs:minInclusive value=“0”/>
<xs:maxInclusive value=“49”/>

</xs:restriction>

</xs:simpleType>

</xs:element>
<xs:element name=“StartStop” type=“xs:string” minOccurs=“0”/>
<xs:element name=“SLSched” minOccurs=“0”>

<xs:annotation>

<xs:documentation>scheduling for streetlight

application command</xs:documentation>

</xs:annotation>
<xs:complexType>

<xs:sequence>

<xs:element name=“StartStop”

minOccurs=“0”>

<xs:simpleType>

<xs:restriction

base=“xs:string”>

<xs:length

value=“24”/>

</xs:restriction>

</xs:simpleType>

</xs:element>
<xs:element name=“SchedFreq”>

<xs:simpleType>

<xs:restriction

base=“xs:string”>

<xs:minLength

value=“20”/>

<xs:maxLength

value=“27”/>

</xs:restriction>

</xs:simpleType>

</xs:element>

</xs:sequence>

</xs:complexType>

</xs:element>

</xs:sequence>

</xs:complexType>

</xs:element>

</xs:schema>

Example XSLT File

<?xml version=“1.0” encoding=“UTF-8”?>
<xsl:stylesheet version=“1.0” xmlns:xsl=“http://www.w3.org/1999/XSL/Transform”
xmlns:ns0=“acmepower.devicemanager.ws” xmlns:xs=“http://www.w3.org/2001/XMLSchema”
xmlns:xsi=“http://www.w3.org/2001/XMLSchema-instance” exclude-result-prefixes=“ns0 xs”>

<xsl:output method=“xml” encoding=“UTF-8” indent=“yes”/>
<xsl:template match=“/”>

<xsl:variablename=“var1_DeviceManager” select=“ns0:DeviceManager”/>
<app:StreetLightApplicationRequest xmlns:app=“acmepower.app0001.app”>

<xsl:for-each select=“$var1_DeviceManager”>

<app:MessageID>

<xsl:value-of select=“string(ns0:MessageID)”/>

</app:MessageID>

</xsl:for-each>
<xsl:for-each select=“$var1_DeviceManager/ns0:CommandRequest”>

<app:CmdID>

<xsl:value-of select=“string(ns0:CommandID)”/>

</app:CmdID>

</xsl:for-each>
<xsl:for-each select=“$var1_DeviceManager/ns0:CommandRequest”>

<app:Cmd>

<xsl:value-of select=“translate(string(ns0:CommandName),

‘flash’, ‘96’)”/>

</app:Cmd>

</xsl:for-each>
<xsl:for-each

select=“$var1_DeviceManager/ns0:CommandRequest/ns0:Device/ns0:CommandValue”>

<app:Flashes>

<xsl:value-of select=“string(floor(number(string(.))))”/>

</app:Flashes>

</xsl:for-each>
<xsl:for-each select=“$var1_DeviceManager/ns0:CommandRequest/ns0:Device”>

<xsl:variable name=“var9_cur” select=“.”/>
<xsl:for-each select=“ns0:start”>

<xsl:variable name=“var8_cur” select=“.”/>
<xsl:variable name=“var2_nil” select=“@xsi:nil”/>
<xsl:variable name=“var7_result”>

<xsl:choose>

<xsl:when test=“string(boolean($var2_nil)) !=

‘false’”>

<xsl:variable

name=“var3_resultof_cast” select=“string($var2_nil)”/>

<xsl:value-of select=“((normalize-

space($var3_resultof_cast) = ‘true’) or (normalize-space($var3_resultof_cast) = ‘1’))”/>

</xsl:when>
<xsl:otherwise>

<xsl:value-of select=“false( )”/>

</xsl:otherwise>

</xsl:choose>

</xsl:variable>
<xsl:if test=“string(not((string($var7_result) != ‘false’))) !=

‘false’”>

<xsl:for-each select=“$var9_cur/ns0:stop”>

<xsl:variable name=“var4_nil”

select=“@xsi:nil”/>

<xsl:variable name=“var6_result”>

<xsl:choose>

<xsl:when

test=“string(boolean($var4_nil)) != ‘false’”>

<xsl:variable

name=“var5_resultof_cast” select=“string($var4_nil)”/>

<xsl:value-of

select=“((normalize-space($var5_resultof_cast) = ‘true’) or (normalize-space($var5_resultof_cast) = ‘1’))”/>

</xsl:when>
<xsl:otherwise>

<xsl:value-of

select=“false( )”/>

</xsl:otherwise>

</xsl:choose>

</xsl:variable>
<xsl:if test=“string(not((string($var6_result)

!= ‘false’))) != ‘false’”>

<app:StartStop>

<xsl:value-of

select=“concat(string($var8_cur), string(.))”/>

</app:StartStop>

</xsl:if>

</xsl:for-each>

</xsl:if>

</xsl:for-each>

</xsl:for-each>
<app:SLSched>

<xsl:for-each

select=“$var1_DeviceManager/ns0:CommandRequest/ns0:Device/ns0:Schedule”>

<xsl:variable name=“var17_cur” select=“.”/>
<xsl:for-each select=“ns0:start”>

<xsl:variable name=“var16_cur” select=“.”/>
<xsl:variable name=“var10_nil” select=“@xsi:nil”/>
<xsl:variable name=“var15_result”>

<xsl:choose>

<xsl:when

test=“string(boolean($var10_nil)) != ‘false’”>

<xsl:variable

name=“var11_resultof_cast” select=“string($var10_nil)”/>

<xsl:value-of

select=“((normalize-space($var11_resultof_cast) = ‘true’) or (normalize-space($var11_resultof_cast) =
‘1’))”/>

</xsl:when>
<xsl:otherwise>

<xsl:value-of

select=“false( )”/>

</xsl:otherwise>

</xsl:choose>

</xsl:variable>
<xsl:if test=“string(not((string($var15_result) !=

‘false’))) != ‘false’”>

<xsl:for-each select=“$var17_cur/ns0:stop”>

<xsl:variable name=“var12_nil”

select=“@xsi:nil”/>

<xsl:variablename=“var14_result”>

<xsl:choose>

<xsl:when

test=“string(boolean($var12_nil)) != ‘false’”>

<xsl:variable name=“var13_resultof_cast” select=“string($var12_nil)”/>
<xsl:value-of select=“((normalize-space($var13_resultof_cast) = ‘true’) or (normalize-

space($var13_resultof_cast) = ‘1’)”/>

</xsl:when>
<xsl:otherwise>

<xsl:value-of select=“false( )”/>

</xsl:otherwise>

</xsl:choose>

</xsl:variable>
<xsl:if

test=“string(not((string($var14_result) != ‘false’))) != ‘false’”>

<app:StartStop>

<xsl:value-of

select=“concat(string($var16_cur), string(.))”/>

</app:StartStop>

</xsl:if>

</xsl:for-each>

</xsl:if>

</xsl:for-each>

</xsl:for-each>
<xsl:for-each

select=“$var1_DeviceManager/ns0:CommandRequest/ns0:Device/ns0:Schedule”>

<xsl:variable name=“var18_ScheduleFrequency”

select=“ns0:ScheduleFrequency”/>

<app:SchedFreq>

<xsl:value-of

select=“concat(concat(concat(string($var18_ScheduleFrequency/ns0:Pattern),
string($var18_ScheduleFrequency/ns0:StartDate)), string($var18_ScheduleFrequency/ns0:StartTime)),
string($var18_ScheduleFrequency/ns0:EndTime))”/>

</app:SchedFreq>

</xsl:for-each>

</app:SLSched>

</app:StreetLightApplicationRequest>

</xsl:template>

<xsl:stylesheet>

XML Request Example 1

<?xmlversion=“1.0”encoding=“UTF-8”?>
<sl:StreetLightApplicationRequest xmlns:sl=“acmepower.app0001.app”
xmlns:xsi=“http://www.w3.org/2001/XMLSchema-instance”
xsi:schemaLocation=“acmepower.app0001.app AcmePower_App0001_app.xsd ”>
<sl:MessageID>aaaaaaaaaaaaaa</sl:MessageID>
<sl:CmdID>aaaaaaaaaaaaaa</sl:CmdID>
<sl:Cmd>95</sl:Cmd>
<sl:Flashes></sl:Flashes>
<sl:StartStop></sl:StartStop>
<sl:SLSched>
<sl:StartStop>201105010000201106010000</sl:StartStop>
<sl:SchedFreq>W201105011700002300001351</sl:SchedFreq>
<sl:SLSched>
</sl:StreetLightApplicationRequest>

XML Request Example 2

<?xml version=“1.0” encoding=“UTF-8”?>
<sl:StreetLightApplication xmlns:sl=“acmepower.app0002.app”
xmlns:xsi=“http://www.w3.org/2001/XMLSchema-instance”
xsi:schemaLocation=“acmepower.app0002.app AcmePower_App0002_app.xsd ”>
<sl:MessageID>SAMPLEMSDID</sl:MessageID>
<sl:CmdID>SAMPLECMDID</sl:CmdID>
<sl:Command>A1</sl:Command>
<sl:Value>0</sl:Value>
<sl:Indx>0</sl:Indx>
<sl:Iterations></sl:Iterations>
<sl:StartStop></sl:StartStop>
<sl:SLSched>

<sl:StartStop>110501170000110601170000</sl:StartStop>
<sl:SchedFreq>W201105011700002300001351</sl:SchedFreq>

</sl:SLSched>
</sl:StreetLightApplication>

1. An integration system for enabling communication between service providers and end-devices, the integration device comprising:
at least one memory for storing data about end-devices;
an interface for receiving communications from service providers intended for a plurality of end-devices and retransmitting the communication to the plurality of end-devices;
wherein the plurality of end-devices are configured to communicate with two or more different service providers and the integration system is configured to translate the incoming communication from the service provider to the protocol corresponding to the end-device.

2. The integration system of claim 1, further comprising a common interface for receiving communications from service providers using a common protocol.

3. The integration system of claim 1, further comprising a processor for implementing access management protocols across a plurality of service providers.

4. The integration system of claim 3, wherein the access management protocols comprise security protocols.

5. The integration system of claim 4, wherein the security protocols comprise at least one of authentication, service provider rights and roles, end-device data, or service provider data.

6. The integration system of claim 1, further comprising an application kiosk for storing applications for distribution to the end-devices.

7. The integration system of claim 1, wherein the service providers desire to communicate with the end-devices to provide applications to the end-devices.

8. The integration system of claim 1, wherein the service providers desire to communicate with the end-devices to query the end-devices.

9. The integration system of claim 1, wherein the service providers desire to request the protocol corresponding to the end device from the integration system.

10. The integration system of claim 1, wherein end-device manufacturers are given rights to update firmware on the end-devices and provide applications and the remaining service providers desire to request their available commands for respective devices

11. The integration system of claim 1, wherein the integration device is further configured to translate communications from the end-devices into a protocol corresponding to the service provider.

12. The integration system of claim 1, wherein the end-devices comprise at least one of customer premise utility devices, mobile devices, hand-held devices, and/or mounted tracking devices or sensors.

13. The integration system of claim 1, wherein the service providers comprise at least one of end-device manufactures, utility companies, and/or third party service providers.

14. The integration system of claim 13, wherein the manufacturers are given rights to update firmware on the end-devices and provide applications and the remaining service providers are given rights to query the end devices.

15. The integration system of claim 13, wherein the manufacturers are given rights to update firmware on the end-devices and provide applications and the remaining service providers desire to request the protocol corresponding to the end device from the integration system.

16. The integration system of claim 1, wherein there are at least 100 end-devices using at least 3 different communication protocols.

17. The integration system of claim 1, wherein there are at least 10,000 end-devices using at least 5 different communication protocols.

18. The integration system of claim 1, wherein there are at least 100,000 end-devices using at least 10 different communication protocols.

19. A method for communicating with a plurality of end-devices the method comprising:
receiving a communication from a service provider;
identifying which plurality of end-devices the communication was intended for;
determining which of two or more communication protocols the plurality of end-devices use;
translating the received communication into the plurality of different communication protocols;
retransmitting the communication to the identified plurality of end-devices.

20. The method of claim 19, wherein the communications from the service providers are received using a common protocol.

21. The method of claim 19, further comprising implementing access management protocols across a plurality of service providers.

22. The method of claim 21, wherein the access management protocols comprise security protocols.

23. The method of claim 22, wherein the security protocols comprise at least one of authentication, service provider rights and roles, end-device data, or service provider data.

24. The method of claim 19, further comprising storing applications for distribution to the end-devices.

25. The method of claim 19, wherein the service providers desire to communicate with the end-devices to provide applications to the end-devices.

26. The method of claim 19, wherein the service providers desire to communicate with the end-devices to query the end-devices.

27. The method of claim 19, wherein the service providers desire to request the protocol corresponding to the end device from the integration system.

28. The method of claim 19, further comprising translating communications from the end-devices into a protocol corresponding to the service provider.

29. The method of claim 19, wherein the end-devices comprise at least one of customer premise utility devices, mobile devices, hand-held devices, and/or mounted tracking devices.

30. The method of claim 19, wherein the service providers comprise at least one of end-device manufactures, utility companies, and/or third party service providers.

31. The method of claim 30, wherein the manufactures are given rights to update firmware on the end-devices and provide applications and the remaining service providers are given rights to query the end devices.

32. The method of claim 30, wherein the manufacturers are given rights to update firmware on the end-devices and provide applications and the remaining service providers desire to request the protocol corresponding to the end device from the integration system.

33. The method of claim 30, wherein the manufacturers are given rights to update firmware on the end-devices and provide applications and the remaining service providers desire to request their available commands for respective devices.

34. The method of claim 19, wherein there are at least 100 end-devices using at least 3 different communication protocols.

35. The method of claim 19, wherein there are at least 10,000 end-devices using at least 5 different communication protocols.

36. The method of claim 19, wherein there are at least 100,000 end-devices using at least 10 different communication protocols.

37. An integration system for enabling communication between service providers and end-devices, the integration system comprising:
a database maintaining data on end-devices;
an application kiosk storing application files for the end-devices, the application files comprising:
(i) a profile for an application representing functional capabilities of the respective application and comprising available commands for respective devices; and
(ii) a policy including configuration data for a deployment environment;
a user interface enabling access to the system by users; and
a services interface for uploading applications to the application kiosk, deploying applications from the application kiosk to a plurality of end-devices based on user requests and the respective application policies, and communicating with the deployed applications using commands defined in the respective application profiles of the applications.

38. The integration system as claimed in claim 37, wherein the end-devices comprise at least one of customer premise devices, mobile devices, hand-held devices, and/or mounted tracking devices such as trucks and plant or shipping equipment or logistics or security or sensors.

39. The integration system as claimed in claim 37, further comprising security management services for managing authentication and access to the integration system.

40. The integration system as claimed in claim 37, wherein the services interface is a web services interface.

41. An integration system for enabling communication between service providers and end-devices including components for selecting and deploying different applications to a plurality of end-devices over a plurality of different infrastructure provider networks.

42. The integration system as claimed in claim 41, including a user interface for remotely selecting applications and causing installation on remote end devices of different infrastructure provider networks.

43. An integration system for enabling communication between service providers and end-devices, comprising:
an application kiosk storing applications to be run on customer devices, the applications comprising one or more of the following:
(i) application code
(ii) a profile representing available commands for the application when run on different respective customer devices; and
(iii) firmware code
(iv) configuration data for a deploying the application on different respective customer devices and in different environments; and
a web services interface for:
(i) uploading applications to the application kiosk,
(ii) deploying applications from the application kiosk to end-devices based on user requests, the configuration data and the code of the applications, and
(iii) communicating with the deployed applications using commands defined in the respective profiles of the applications; and
a transformation component for processing messages received from customers and generating commands from the messages using the profiles to control the devices.

44. The integration system as claimed in claim 43, wherein the transformation component executes transformation rules of said profiles to generate the commands.

45. The integration system as claimed in claim 44, wherein the transformation component executes the transformation rules of said profiles to convert data from the end-devices, by the web services interface, into messages for generating displays for users.

46. An integration system, including:
a device and customer database maintaining data on customer devices at customers premises;
an application kiosk storing application files for customer devices, the files including:
(i) a profile for each application representing functional capabilities of the respective application and including available commands for respective devices; and
(ii) a policy including configuration data for a deployment environment;
security management services for managing authentication and access to the integration system;
a user interface enabling authenticated access to the system by users; and
a web services interface for uploading applications to the application kiosk, deploying applications from the application kiosk to devices based on user requests and the respective application policy, and communicating with the deployed applications using commands defined in the respective application profiles of the applications.

47. An integration system including components for selecting and deploying different applications to customer equipment devices over different infrastructure provider networks.

48. An integration system as claimed in claim 47, including a user interface for remotely selecting applications and causing installation on remote end devices of different infrastructure provider networks.

49. An integration system, including:
an application kiosk storing application bundles for applications to be run on customer devices, the bundles each including:
(i) a profile representing available commands for the application when run on different respective customer devices; and
(ii) configuration data for a deploying the application on different respective customer devices and in different environments; and
a web services interface for uploading application bundles to the application kiosk, deploying applications from the application kiosk to devices based on user requests and using the configuration data and code of the applications, and communicating with the deployed applications using commands defined in the respective profiles of the applications; and
a transformation component for processing messages received from user equipment and generating commands from the messages using the profiles to control the devices.

50. An integration system as claimed in claim 49, wherein the transformation component executes transformation rules of said profiles to generate the commands.

51. An integration system as claimed in claim 50, wherein the transformation component executes the transformation rules of said profiles to converts data from the devices, by the web services interface, into messages for generating displays for users.
